(19) United States
(12) Patent Application Publication
(10) Pub. No.: US 2024/0119739 A1
(43) Pub. Date: Apr. 11, 2024

(54) COMPUTER-READABLE RECORDING MEDIUM STORING MACHINE LEARNING PROGRAM, MACHINE LEARNING METHOD, AND INFORMATION PROCESSING DEVICE

(71) Applicant: Fujitsu Limited, Kawasaki-shi (JP)

(72) Inventors: Suguru YASUTOMI, Kawasaki (JP); Masayuki HIROMOTO, Kawasaki (JP)

(73) Assignee: Fujitsu Limited, Kawasaki-shi (JP)

(21) Appl. No.: 18/221,417

(22) Filed: Jul. 13, 2023

(30) Foreign Application Priority Data
Oct. 11, 2022 (JP) 2022-163400

(51) Int. Cl. G06V 20/58; G06V 10/25; G06V 10/764

(52) U.S. Cl. CPC G06V 20/58; G06V 10/25; G06V 10/764; G06V 2201/07

(57) ABSTRACT

A non-transitory computer-readable recording medium storing a machine learning program for causing a computer to execute a process, the process includes inputting moving image data that includes at least a first frame image and a second frame image to a first machine learning model trained by using training data, and training an encoder by detecting a first object and a second object from the first frame image and the second frame image, respectively, based on an inference result by the first machine learning model, determining identity between the first object and the second object that have been detected, and inputting, to the encoder, first data in a first image area that includes the first object and second data in a second image area that includes the second object, the first object and the second object having been determined to have the identity.

### CROSS-REFERENCE TO RELATED APPLICATION

This application is based upon and claims the benefit of priority of the prior Japanese Patent Application No. 2022-163400, filed on Oct. 11, 2022, the entire contents of which are incorporated herein by reference.

### FIELD

The embodiment discussed herein is related to a machine learning program, a machine learning method, and an information processing device.

### BACKGROUND

There has been known an object tracking technique for tracking an object in a moving image using machine learning. The object tracking technique includes an object detection technique and a tracking technique, and performance of object tracking depends on performance of object detection. When it fails to obtain a sufficient amount of training data for the object detection, the performance of the object detection may be lowered due to over-training.

There has been known a label propagation method as an example of a technique for increasing the training data amount. The label propagation method propagates (copies) a data label to unlabeled data in temporal or spatial proximity using a result of the object tracking. The label propagation method generates a new label based on an inference result inferred with a confidence level equal to or higher than a predetermined value.

Yifu Zhang et al. “ByteTrack: Multi-Object Tracking by Associating Every Detection Box” arXiv:2110.06864v3 [cs.CV] 7 Apr. 2022 is disclosed as related art.

### SUMMARY

According to an aspect of the embodiments, a non-transitory computer-readable recording medium storing a machine learning program for causing a computer to execute a process, the process includes inputting moving image data that includes at least a first frame image and a second frame image to a first machine learning model trained by using training data, and training an encoder by detecting a first object and a second object from the first frame image and the second frame image, respectively, based on an inference result by the first machine learning model, determining identity between the first object and the second object that have been detected, and inputting, to the encoder, first data in a first image area that includes the first object and second data in a second image area that includes the second object, the first object and the second object having been determined to have the identity.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating an exemplary label propagation method;

FIG. 2 is a diagram for explaining contrastive learning;

FIG. 3 is a diagram for explaining training of a contrastive learning model according to an embodiment;

FIG. 4 is a diagram illustrating an exemplary training process of an object tracking model by an information processing device according to the embodiment;

FIG. 5 is a diagram schematically illustrating an example of training data for object detection according to the embodiment;

FIG. 6 illustrates an example of unlabeled moving image data to be input to the trained object tracking model illustrated in FIG. 4;

FIG. 7 is a diagram illustrating an exemplary training process of the contrastive learning model in the information processing device according to the embodiment;

FIG. 8 is a diagram illustrating an exemplary training process of an object detection model in the information processing device according to the embodiment;

FIG. 9 is a block diagram illustrating an exemplary functional configuration in a training phase by the information processing device according to the embodiment;

FIG. 10 is a block diagram illustrating an exemplary functional configuration in an inference phase by the information processing device according to the embodiment;

FIG. 11 is a block diagram illustrating an exemplary hardware (HW) configuration of a computer that implements functions of the information processing device according to the embodiment;

FIG. 12 is a flowchart illustrating an example of operation in the training phase by the information processing device according to the embodiment;

FIG. 13 is a flowchart illustrating an example of operation in the inference phase by the information processing device according to the embodiment;

FIG. 14 is a diagram illustrating an exemplary training process of an object detection model by an information processing device according to a first variation;

FIG. 15 is a flowchart illustrating an example of operation in a training phase by the information processing device according to the first variation;

FIG. 16 is a flowchart illustrating an example of operation in an inference phase by the information processing device according to the first variation;

FIG. 17 is a diagram illustrating a decoupled object detection model according to a second variation;

FIG. 18 is a diagram illustrating an exemplary training process of the decoupled object detection model by an information processing device according to the second variation;

FIG. 19 is a block diagram illustrating an exemplary functional configuration in a training phase by the information processing device according to the second variation;

FIG. 20 is a block diagram illustrating an exemplary functional configuration in an inference phase by the information processing device according to the second variation;

FIG. 21 is a flowchart illustrating an example of operation in the training phase by the information processing device according to the second variation; and

FIG. 22 is a flowchart illustrating an example of operation in the inference phase by the information processing device according to the second variation.

### DESCRIPTION OF EMBODIMENTS

Since the training data obtained by the label propagation method is generated based on the inference result inferred with the confidence level equal to or higher than the predetermined value, it may be difficult to consider a situation where there is a perturbation (e.g., influence of an occlusion, etc.) This is because the confidence level is lowered when a perturbation occurs. Therefore, even when the training data is increased by the label propagation method, it may be difficult to improve the performance of the object detection.

### [A] Related Art

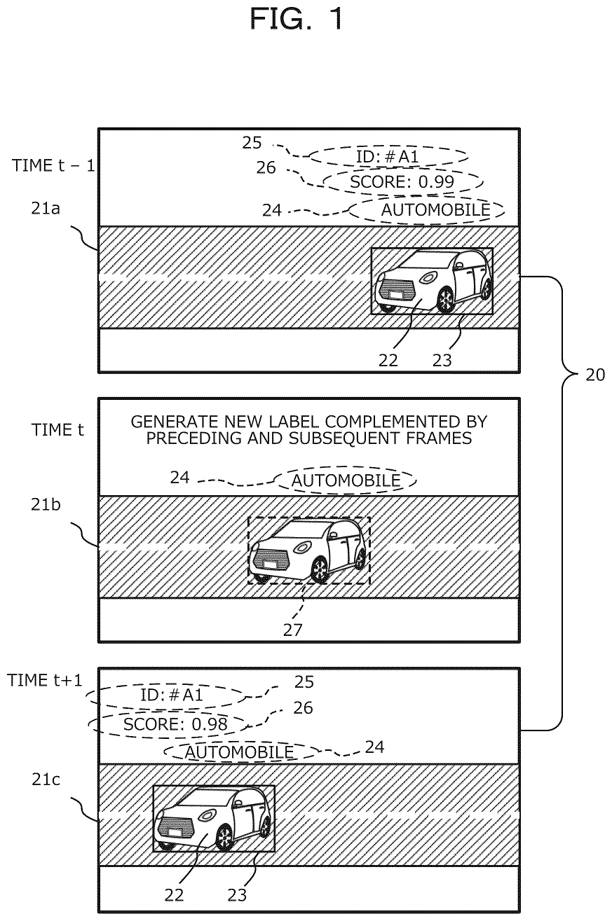

FIG. 1 is a diagram schematically illustrating an exemplary label propagation method.

As illustrated in FIG. 1, in the related art, unknown unlabeled moving image data 20 is input to an object tracking model (not illustrated) trained by using existing training data (not illustrated). The unlabeled moving image data 20 includes a plurality of frame images 21a, 21b, and 21c.

An inference process is performed on the unlabeled moving image data 20 using the object tracking model. As a result, an object 22 is detected. Boundary position information associated with the object 22 may be indicated by a bounding box 23. The object tracking model estimates a class 24 of the object 22. In FIG. 1, the class 24 is an “automobile”. In the present specification, the “object” is not limited to an automobile as long as it is an object to be detected. As an example, the “object” may be an automobile, a truck, a motorcycle, a bicycle, or a person.

The bounding box 23 of each object 22 may be associated with identification information 25 (object identifier (ID)) for identifying identity of the object 22 and a confidence level 26. The confidence level (confidence) 26 may be a weight of a determination result of the class 24 of the object 22. It is indicated that an object detection model has made the determination with higher accuracy as a numerical value of the confidence level 26 is closer to 1.

In FIG. 1, labeled data is newly generated using at least one of the bounding box 23, the class 24, the identification information 25, the confidence level 26, and the like, which are object tracking results.

As an example, a new label corresponding to the bounding box 23 (and the class 24) with the confidence level 26 higher than a predetermined value may be generated. In FIG. 1, the bounding box 23, the class 24, and the like may be a new label in the frame image 21a and the frame image 21c.

In the example illustrated in FIG. 1, the object 22 is not detected in the frame image 21b at time t. However, the object 22 is detected in the preceding and subsequent frame images 21a and 21c (at time t−1 and t+1). In this case, a bounding box 27 at the time t may be added as a complement based on the bounding box 23 or the like in the preceding and subsequent frame images 21a and 21c. The complementary bounding box 27 and the class 24 may be used as a new label to generate new labeled data.

Note that the complementary bounding box 27 may be generated in a case where the confidence level 26 of the object 22 detected in the preceding and subsequent frame images (21a and 21c in FIG. 1) is equal to or higher than a predetermined threshold value. Moreover, new labeled data may be generated in consideration of not only the confidence level in the object detection but also the confidence level based on a tracking algorithm.

In the related art illustrated in FIG. 1, a new label is generated based on an inference result in which the confidence level 26 is equal to or higher than a predetermined value. On the other hand, the performance of the object detection may be rather degraded in a case where a new label is generated based on an inference result in which the confidence level 26 is lower than the predetermined value.

Since the confidence level 26 is likely to be lower when there is a “perturbation”, data when there is a “perturbation” is often not considered for generation of new labeled data. Therefore, according to the method illustrated in FIG. 1, labeled data in consideration of a case where the confidence level 26 is lowered by a perturbation may not be generated. Note that the “perturbation” may include, for example, that a part of the object is occluded by another object, a motion blur (e.g., blurring that occurs when a moving object is captured by a camera), an angular change of the object, an influence of illuminance, and the like.

An object detection model robust to an influence of a perturbation may not be obtained even if the object detection model is trained by using the labeled data generated by the method illustrated in FIG. 1 as new training data. In view of the above, it is assumed that an object detection model robust to a perturbation is generated.

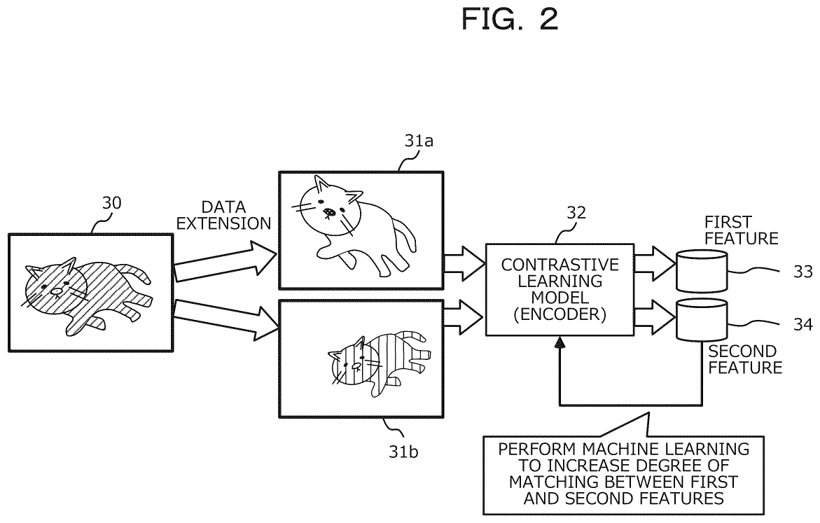

FIG. 2 is a diagram for explaining contrastive learning. The contrastive learning is a type of self-supervised learning. FIG. 2 exemplifies, as a simple example, a case where image data reflecting a “cat” is input as input data 30 and an object label “cat” is output as an output.

In the contrastive learning, two pieces of extended data 31 (31a and 31b) are obtained from the input (input data 30) through two types of data extension. For example, the data extension may be processing of making, with respect to the input data 30 that is an original image, changes of parallel translation, rotation, scaling, vertical inversion, horizontal inversion, brightness adjustment, and a plurality of combinations thereof.

A first feature vector 33 and a second feature vector 34 are obtained by each of the extended data 31a and 31b obtained by the two types of data extension being input to a contrastive learning model 32.

The two pieces of extended data 31a and 31b are data having been subject to different changes without changing the essence of the object. Therefore, the first feature vector 33 and the second feature vector 34 match or are similar due to the unchanged essence of the object.

In the contrastive learning, machine learning of the contrastive learning model 32 is carried out such that a degree of matching (similarity) between the two, which are the first feature vector 33 (zᵢ) and the second feature vector 34 (zⱼ), becomes higher. The contrastive learning model 32 is an encoder. As an example, a loss function L_{φ}=−sim(zᵢ, zⱼ) may be calculated, and the parameter φ may be updated such that a value of the loss function L_{φ} is minimized.

### [B] Embodiment

Hereinafter, an embodiment of techniques capable to reduce an influence of a perturbation to improve performance of object detection will be described with reference to the drawings. Note that the embodiment to be described below is merely an example, and there is no intention to exclude application of various modifications and techniques not explicitly described in the embodiment. For example, the present embodiment may be variously modified and implemented without departing from the gist thereof. Furthermore, each drawing is not intended to include only the constituent elements illustrated in the drawing, and may include another function and the like.

Hereinafter, each of the same reference signs denotes a similar part in the drawings, and thus description thereof will be omitted.

### [B-1] Description of Training Process According to Embodiment

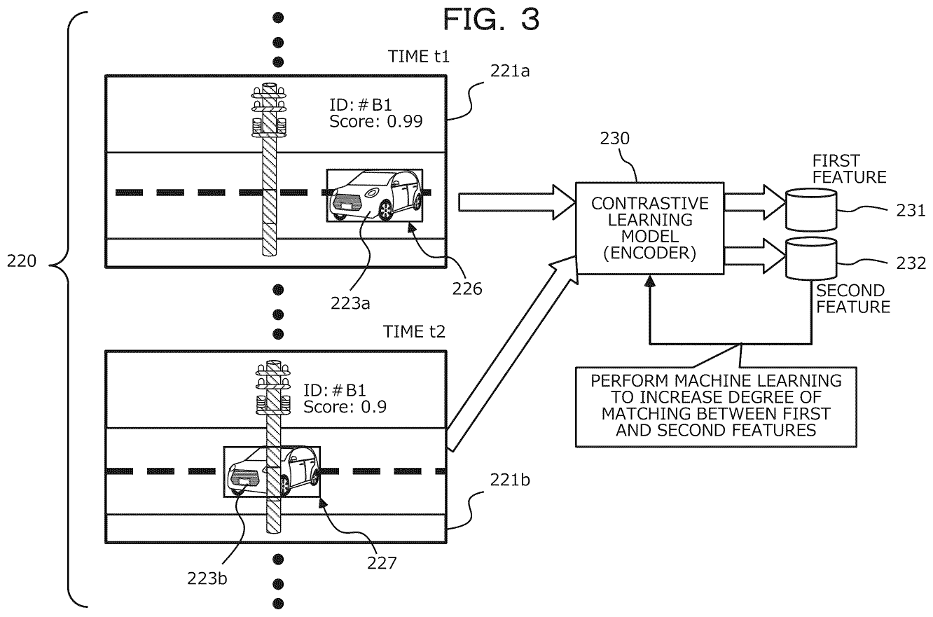

FIG. 3 is a diagram illustrating an outline of training of a contrastive learning model 230 according to the embodiment. Image data 226 and 227 of a plurality of objects 223a and 223b recognized as the same object by an object tracking model (to be described later) in frame images 221 (221a and 221b) at different times of unlabeled moving image data 220 (moving image) are used for contrastive learning. The contrastive learning model 230 is trained to increase a degree of matching between a first feature vector 231 and a second feature vector 232 obtained as outputs when the respective image data 226 and 227 are output to the contrastive learning model 230.

According to the method of the present embodiment, the images (226 and 227) of the pair of the objects (223a and 223b), which are the same object reflected in the frame images 221 at different times, are used as data to be input to the contrastive learning model 230 instead of being based on two types of data extension. The training of the contrastive learning model 230 will be described later.

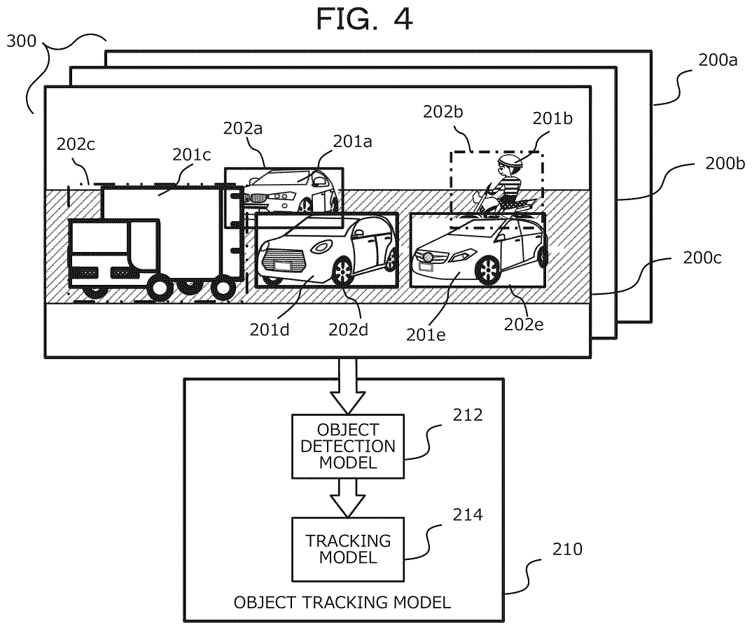

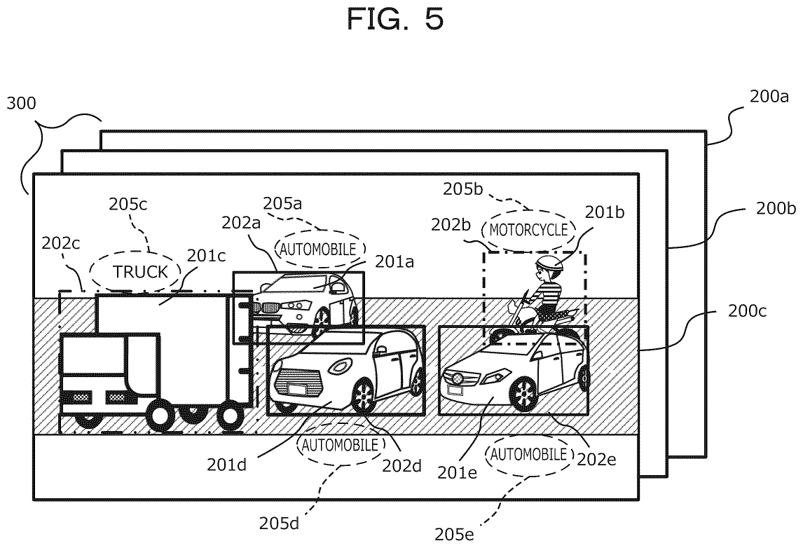

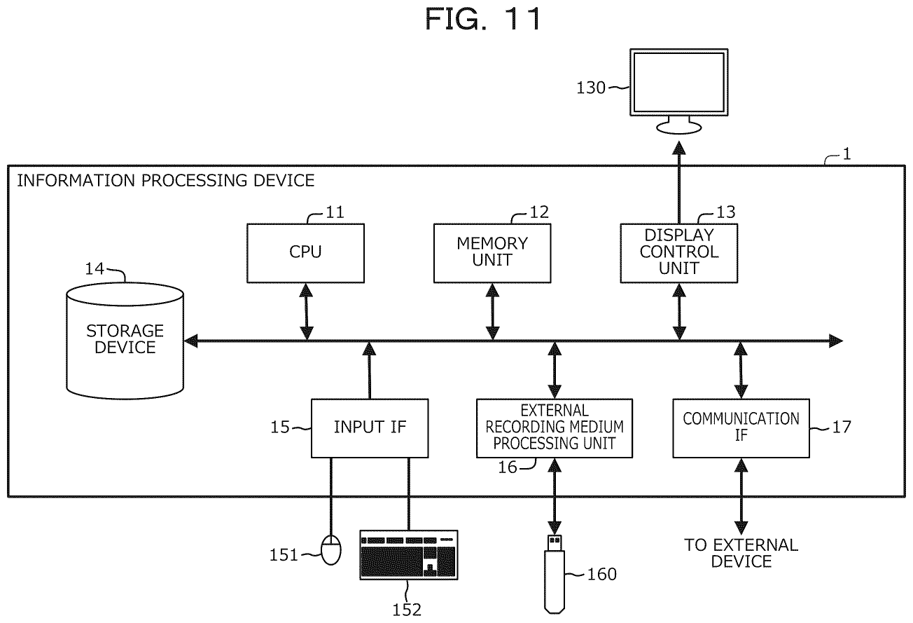

FIG. 4 is a diagram illustrating an exemplary training process of an object tracking model 210 by an information processing device 1 (FIG. 11) according to the embodiment. FIG. 5 is a diagram schematically illustrating an example of training data 300 for object detection according to the embodiment.

The training data 300 (learning data) may be a data set for training of the object tracking model 210. The training data 300 may be a moving image, and may include a plurality of frame images 200a, 200b, and 200c (which may be collectively referred to as frame images 200). The number of the frame images 200 is not limited to the case illustrated in FIGS. 4 and 5.

The training data 300 in FIG. 5 includes objects 201a to 201e. The object 201a is an automobile, 201b is a motorcycle, 201c is a truck, 201d is an automobile, and 201e is an automobile. The objects 201a to 201e may be collectively referred to as objects 201.

Boundary position information of the respective objects 201 may be indicated by bounding boxes 202a to 202e (which may be collectively referred to as bounding boxes 202). The boundary position information may include one plane coordinate of a height, a width, and a vertex of each of the bounding boxes 202.

The respective objects 201 may be associated with classes 205a to 205e (which may be collectively referred to as classes 205) indicating object types such as an automobile, a motorcycle, a truck, and the like.

As illustrated in FIG. 4, the object tracking model 210 may include an object detection model 212 and a tracking model 214. The object detection model 212 detects the objects 201 from the moving image. The tracking model 214 allocates the same identification information 225 (object ID) to the same objects 201 among the plurality of frame images 200a, 200b, and 200c included in the moving image.

An existing method may be used as the object detection model 212. As an example, an object detection method such as Regions with Convolutional Neural Network (R-CNN), You Only Look Once (YOLO), Single Shot MultiBox Detector (SSD), Deformed Convolutional Networks (DCN), End-to-End Object Detection with Transformers (DETR), or the like may be used. Therefore, detailed description will be omitted.

Various methods in existing multiple object tracking (MOT) techniques may be used as the tracking model 214. As an example, feature vectors for the bounding boxes 202 for the objects 201 detected by the object detection model 212 are calculated. Motion prediction of the objects 201 is carried out using optical flow estimation and a Kalman filter. Matching of the objects 201 being tracked is carried out using the feature vectors and a result of the motion prediction. As a result, the same identification information 225 (object ID) is allocated to the objects 201 determined to be the same. For example, the tracking model 214 is a model using ByteTrack. However, the tracking model 214 is not limited to this case.

Parameters of the object detection model 212 and the tracking model 214 are adjusted to optimum values based on machine learning.

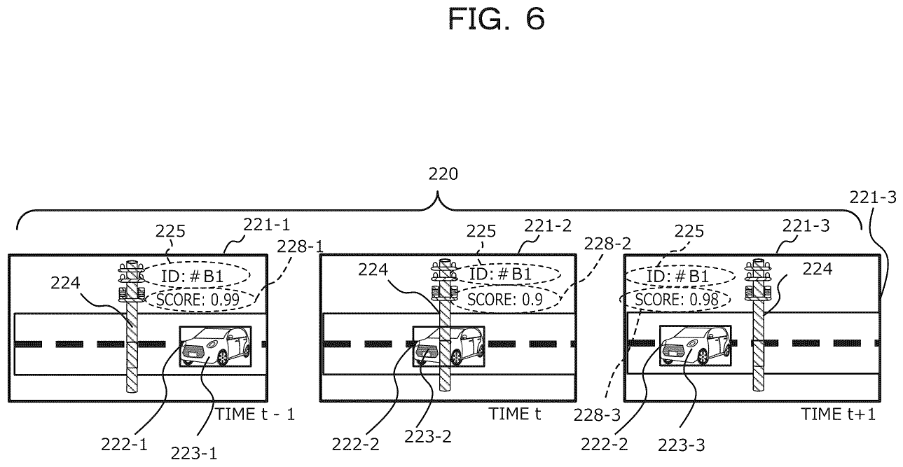

FIG. 6 illustrates an example of the unlabeled moving image data 220 to be input to the trained object tracking model 210 illustrated in FIG. 4. FIG. 6 also illustrates results (e.g., bounding boxes 222, identification information 225, and confidence levels 228) of label estimation by the object tracking model 210 (FIG. 5).

The unlabeled moving image data 220 is an example of moving image data. The unlabeled moving image data 220 includes a plurality of frame images 221-1 to 221-3. The information processing device 1 inputs the unlabeled moving image data 220 to the object tracking model 210 with a fixed parameter.

The information processing device 1 detects an object 223-1 (e.g., first object) from the frame image 221-1 by inference processing of the object tracking model 210. Likewise, the information processing device 1 detects an object 223-2 from the frame image 221-2 and detects an object 223-3 from the frame image 221-3 by the inference processing of the object tracking model 210.

The information processing device 1 determines identity of the plurality of detected objects 223-1 to 223-3 using the object tracking model 210. For example, the information processing device 1 determines the identity between the object 223a (e.g., first object) and the object 223b (e.g., second object) based on the identification information 225 (e.g., object ID), which is one of inference results of the object tracking model 210. The identification information 225 (e.g., object ID) may be information for identifying the identity of the objects 223. The identity means that the objects 223 are the same individual.

The same identification information 225 (e.g., object ID) is allocated to the same objects 223 even among the different frame images 221-1 to 221-3. For example, the tracking model 214 (e.g., tracking algorithm) of the object tracking model 210 links the same objects 223 in images at different times.

The information processing device 1 may estimate bounding boxes 222-1 to 222-3 as an example of the boundary position information regarding the objects 223. Furthermore, the information processing device 1 may estimate a class (see reference sign 24 in FIG. 1, etc.) Illustration of the class is omitted in FIG. 6.

The information processing device 1 may also estimate confidence levels 228-1 to 228-3. The confidence levels 228-1 to 228-3 may be weights of class determination results of the objects 223. The confidence levels 228-1 to 228-3 are different among the frame images 221 corresponding to different times. This is due to a perturbation such as presence of an occlusion 224 that occludes the objects 223 or the like.

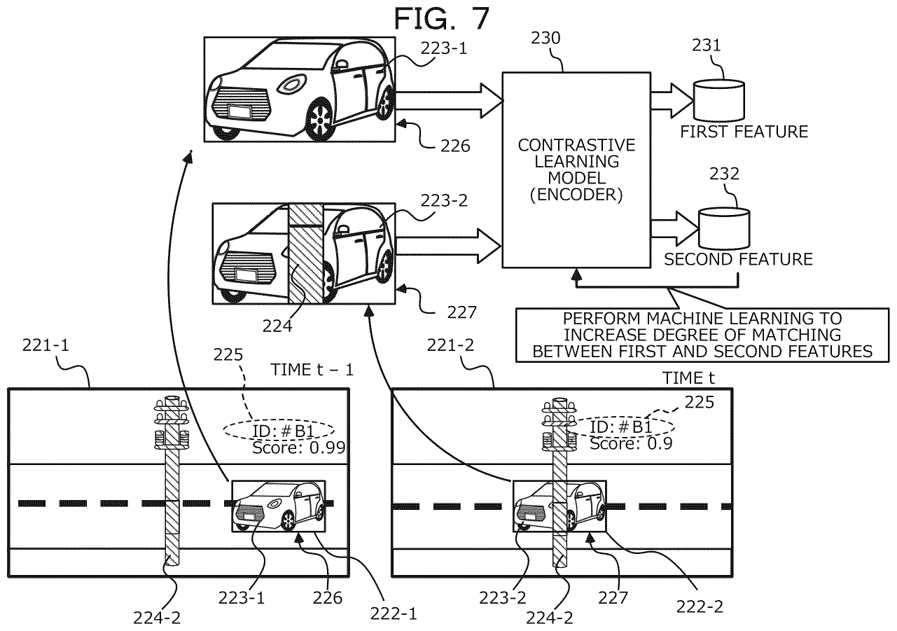

FIG. 7 is a diagram illustrating an exemplary training process of the contrastive learning model 230 in the information processing device 1 according to the embodiment.

In FIG. 7, the frame image 221-1 and the frame image 221-2 are examples of a first frame image and a second frame image. The first frame image and the second frame image may be any frame images corresponding to times different from each other.

In a case where the object 223-1 (e.g., first object) and the object 223-2 (e.g., second object) are determined to be identical, the first data 226 and the second data 227 are input to the contrastive learning model 230 as paired images. As a result, the contrastive learning model 230 is trained. The contrastive learning model 230 is an exemplary encoding unit (e.g., encoder) to which the first data 226 and the second data 227 are input. A plurality of pairs of images may be obtained. The number of pairs may be set to a number sufficient for the contrastive learning.

The first data 226 is image data in a first image area including the object 223-1 (e.g., first object) in the unlabeled moving image data 220. The second data 227 is image data in a second image area including the object 223-2 (e.g., second object) in the unlabeled moving image data 220.

As an example, the first image area may be the rectangular bounding box 222-1 surrounding the object 223-1 (e.g., first object), and the second image area may be the rectangular bounding box 222-2 surrounding the object 223-2 (e.g., second object).

The first data 226 may be image data cut out from the frame image 221-1 (e.g., first frame image) according to the shape and position of the bounding box 222-1. The second data 227 may be image data cut out from the frame image 221-2 (e.g., second frame image) according to the shape and position of the bounding box 222-2. However, the first data 226 and the second data 227 are not limited to this case.

It is sufficient if the first data 226 is image data of an area including the object 223-1 (e.g., first object). The first data 226 may be the entire frame image 221-1, or may be a part of the frame image 221-1. In the example of FIG. 7, the first data 226 is a part of the frame image 221-1.

Likewise, it is also sufficient if the second data 227 is image data of an area including the object 223-2 (e.g., second object). The second data 227 may be the entire frame image 221-2, or may be a part of the frame image 221-2. In the example of FIG. 7, the second data 227 is a part of the frame image 221-2.

The first feature vector 231 and the second feature vector 232 are obtained by each of the first data 226 including the object 223-1 and the second data 227 including the object 223-2 being input to the contrastive learning model 230. The first feature vector 231 is an exemplary first feature, and the second feature vector 232 is an exemplary second feature.

For example, the first data 226 and the second data 227 are image data for the same object 223. However, since the corresponding times (t and t−1) are different, there are differences between the first data 226 and the second data 227, such as an angle of the object 223, presence or absence of the occlusion 224, presence or absence of a motion blur, a difference in illumination, and the like.

Therefore, training similar to original contrastive learning may be carried out using the first data 226 and the second data 227 instead of extended data 31a and 31b obtained by data extension from the same data.

Moreover, the first data 226 and the second data 227 are generated in consideration of the differences such as the angle of the object 223, the presence or absence of the occlusion 224, the presence or absence of the motion blur, the difference in illumination, and the like, for example, the “perturbation”. Therefore, it becomes possible to train the contrastive learning model 230 in consideration of the “perturbation” by training the contrastive learning model 230 using the first data 226 and the second data 227.

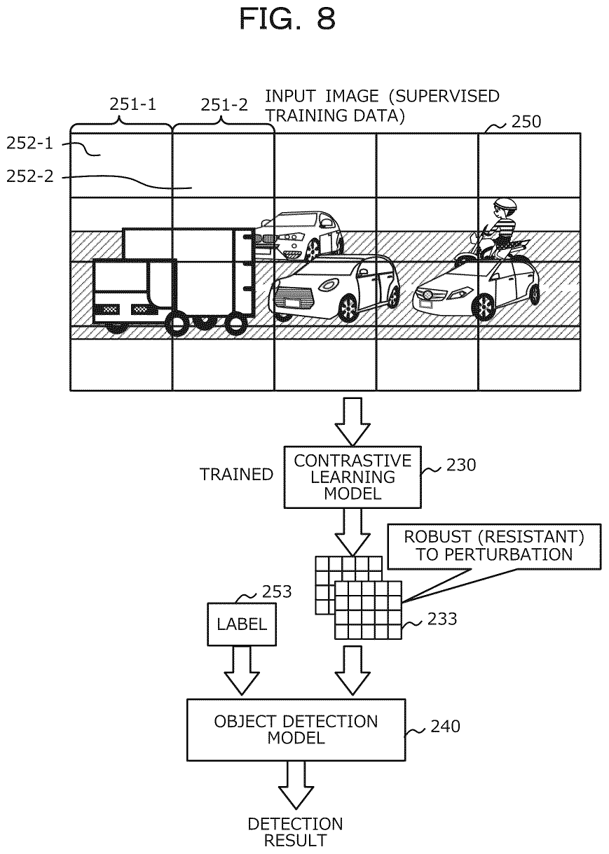

FIG. 8 is a diagram illustrating an exemplary training process of an object detection model 240 in the information processing device 1 according to the embodiment. The information processing device 1 newly trains the object detection model 240 using the trained contrastive learning model 230 illustrated in FIG. 7. The object detection model 240 is an exemplary second machine learning model that detects an object from an image based on the trained contrastive learning model 230.

The object detection model 240 may be a deep neural network (DNN) in which a hidden layer (intermediate layer) is multi-layered between an input layer and an output layer. A known object detection method may be used as the object detection model 240 in a similar manner to the object detection model 212. Therefore, detailed description will be omitted. The object detection model 240 may be the object detection model 212, or may be a different model.

Training image data 250 is prepared. As an example, the training image data 250 may be supervised training data including image data and a label 253. The information processing device 1 divides the training image data 250 into a plurality of divided regions 251 (251-1, 251-2, and so on) to obtain a plurality of divided images 252 (252-1, 252-2, and so on). The plurality of divided images 252 (252-1, 252-2, and so on) may be called patches. Each of the divided regions 251 may have a portion overlapping each other. The generation of the divided images 252 may be performed by a sliding window technique. The sliding window technique obtains a patch for each position while sliding a frame called a window.

The information processing device 1 inputs each of the divided images 252 to the trained contrastive learning model 230 (see FIG. 7) with a fixed parameter, and obtains a feature vector (e.g., representation vector) of each of them. As an example, the information processing device 1 calculates, for each frame, a feature map 233 represented by the feature vector of each of the divided regions 251.

The information processing device 1 inputs the label 253 and the feature map 233 to the object detection model 240. The label 253 may include a class (annotation). The object detection model 240 carries out machine learning of the boundary position information of the object and the feature of the object using the feature map 233 and the label 253. An existing procedure method may be used as the object detection model 240. As an example, an object detection method such as Regions with Convolutional Neural Network (R-CNN), You Only Look Once (YOLO), Single Shot MultiBox Detector (SSD), Deformed Convolutional Networks (DCN), DETR, or the like may be used.

At a time of inference as well, the information processing device 1 divides the input image into the divided images 252. The information processing device 1 inputs each of the divided images 252 to the trained contrastive learning model 230 (see FIG. 7) with the fixed parameter to generate a feature map. The information processing device 1 inputs the feature map 233 to the trained object detection model 240, and infers the label 253 such as the class, the boundary position information (bounding box 222), the confidence level 228, and the like.

The information processing device 1 generates the feature map 233 robust (resistant) to a perturbation by the inference result of the contrastive learning model 230 trained by using the frame images 221 at different times. Then, the information processing device 1 trains the object detection model 240 based on the feature map 233. Therefore, according to the machine learning method according to the present embodiment, it becomes possible to reduce an influence of a perturbation and to improve performance of object detection.

### [B-2] Exemplary Functional Configuration of Information Processing Device 1 According to Embodiment

### [B-2-1] Training Phase

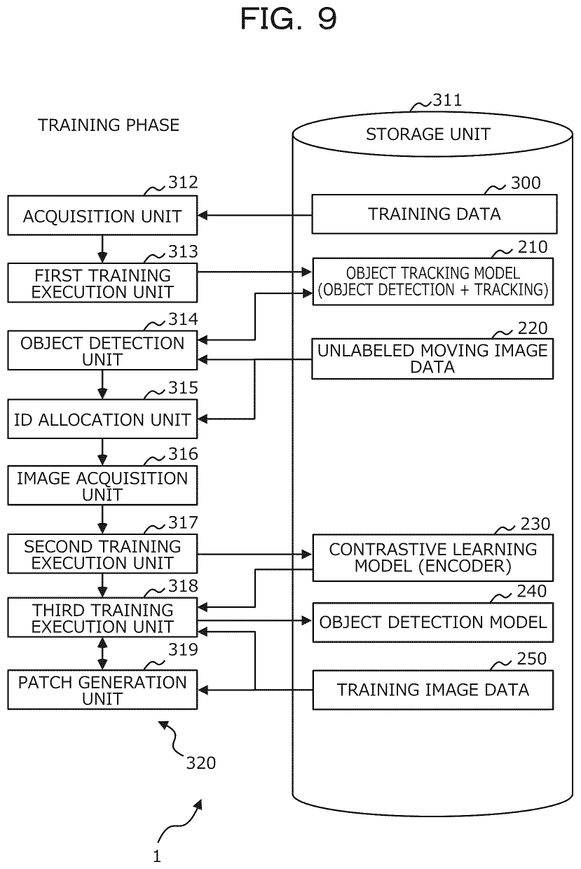

FIG. 9 is a block diagram illustrating an exemplary functional configuration in a training phase by the information processing device 1 according to the embodiment. The information processing device 1 is an exemplary computer that performs a training process.

As illustrated in FIG. 9, the information processing device 1 may illustratively include a storage unit 311, an acquisition unit 312, a first training execution unit 313, an object detection unit 314, an ID allocation unit 315, an image acquisition unit 316, a second training execution unit 317, a third training execution unit 318, and a patch generation unit 319. The configuration of those 312 to 319 is an example of a control unit 320.

The storage unit 311 is an exemplary storage area, and stores various types of data to be used by the information processing device 1. The storage unit 311 may be implemented by, for example, a storage area included in one or both of a memory unit 12 and a storage device 14 illustrated in FIG. 11 to be described later.

As illustrated in FIG. 9, the storage unit 311 may illustratively be capable of storing the training data 300, the object tracking model 210, the unlabeled moving image data 220, the contrastive learning model 230, the object detection model 240, the training image data 250, and the like.

Information stored in the storage unit 311 may be in a table format or another format. As an example, at least one of the pieces of information stored in the storage unit 311 may be in various formats such as a database (DB), an array, or the like.

The acquisition unit 312 obtains various kinds of information to be used in the information processing device 1. For example, the acquisition unit 312 obtains the training data 300 from the storage unit 311. The training data 300 (e.g., learning data) may be a data set for training of the object tracking model 210.

The first training execution unit 313 inputs the training data 300 to the object tracking model 210 (e.g., first machine learning model) to train the object tracking model 210.

The object detection unit 314 may input, to the trained object tracking model 210, the unlabeled moving image data 220 including at least the frame image 221-1 (example of the first frame image) and the frame image 221-2 (example of the second frame image). The object detection unit 314 detects the object 223-1 (example of a first object) from the frame image 221-1 based on the inference result of the object tracking model 210. Likewise, the object detection unit 314 detects the object 223-2 (example of a second object) from the frame image 221-2 based on the inference result of the object tracking model 210.

The ID allocation unit 315 determines identity between the first object (object 223-1, etc.) and the second object (object 223-2, etc.) based on the inference result of the object tracking model 210. When the object 223-1 and the object 223-2 are the same object, the ID allocation unit 315 allocates the same identification information 225 (e.g., object ID) to the object 223-1 and the object 223-2.

When the object 223-1 and the object 223-2 are determined to be identical to each other, the image acquisition unit 316 obtains the first data 226 and the second data 227. The first data 226 is image data in the first image area including the object 223-1, and the second data 227 is image data in the second image area including the object 223-2. The first data 226 may be image data cut out from the frame image 221-1 according to the shape and position of the bounding box 222-1. The second data 227 may be image data cut out from the frame image 221-2 according to the shape and position of the bounding box 222-2.

The second training execution unit 317 inputs the first data 226 and the second data 227 to the contrastive learning model 230 to train the contrastive learning model 230. As an example, the second training execution unit 317 inputs the first data 226 to the contrastive learning model 230 to obtain the first feature vector 231 (example of a first feature) output from the contrastive learning model 230. Likewise, the second training execution unit 317 inputs the second data 227 to the contrastive learning model 230 to obtain the second feature vector 232 (example of a second feature) output from the contrastive learning model 230. The second training execution unit 317 adjusts a parameter of the contrastive learning model 230 to increase the degree of matching between the first feature vector 231 (zᵢ) and the second feature vector 232 (zⱼ). As an example, a loss function L_{φ}=−sim(zᵢ, zⱼ) may be calculated, and the parameter φ may be updated such that a value of the loss function L_{φ} is minimized.

The third training execution unit 318 trains the object detection model 240 that detects an object from an image based on the trained contrastive learning model 230 with a fixed parameter. The third training execution unit 318 uses the training image data 250 for training of the object detection model 240. The training image data 250 may include an image and the label 253.

The training image data 250 may be partially or entirely in common with the training data 300, or may be data different from the training data 300.

The training image data 250 is divided into a plurality of the divided regions 251 by the patch generation unit 319, and a plurality of the divided images 252 (e.g., patches) is generated. The size of the divided region 251 may be determined in advance according to a standard size or the like of the object.

The third training execution unit 318 inputs each of the divided images 252 to the trained contrastive learning model 230 (see FIG. 7) with the fixed parameter, and obtains a feature vector (e.g., representation vector) of each of them. As an example, the third training execution unit 318 calculates, for each frame, the feature map 233 represented by the feature vector of each of the divided regions 251.

The third training execution unit 318 inputs the feature map 233 and the label 253 to the object detection model 240 for training. As a result, a parameter is updated in the object detection model 240 based on the feature for each position in the feature map 233 and the label 253 such as the bounding box 222, the class, and the like as ground truth.

Since it is possible to train the object detection model 240 using the feature map 233 robust (e.g., resistant) to a perturbation, the object detection model 240 robust to the perturbation may be achieved.

It becomes possible to increase the data volume of the feature map 233 generated using a variety of data reflecting the angle of the object 223, the presence or absence of the occlusion 224, the presence or absence of the motion blur, the difference in illumination, and the like. Therefore, by training the object detection model 240 using the feature map 233 in which the number of data is increased, it becomes possible to suppress performance deterioration of object detection caused by over-training of the object detection model 240.

### [B-2-2] Inference Phase

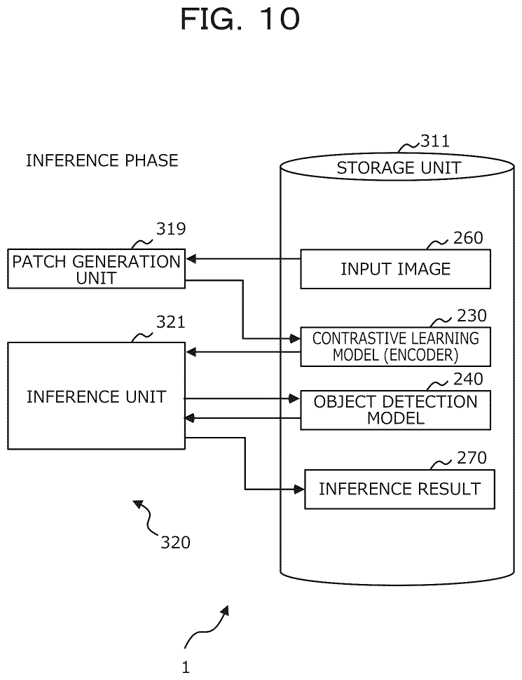

FIG. 10 is a block diagram illustrating an exemplary functional configuration in an inference phase by the information processing device 1 according to the embodiment.

The information processing device 1 includes the storage unit 311, the patch generation unit 319, and an inference unit 321. The patch generation unit 319 and the inference unit 321 is an example of the control unit 320.

The storage unit 311 may include the contrastive learning model 230 and the object detection model 240. The contrastive learning model 230 and the object detection model 240 may have been trained and may have fixed parameters.

The storage unit 311 may store an input image 260 to be subject to object detection. The storage unit 311 may store an inference result 270 obtained by inference processing.

The patch generation unit 319 obtains the input image 260, divides the input image 260 into a plurality of the divided regions 251, and generates a plurality of the divided images 252 (patches). The divided region 251 and the divided image 252 are similar except for a difference regarding whether the target image is the training image data 250 or the input image 260.

The inference unit 321 inputs each of the divided images 252 to the trained contrastive learning model 230 (FIG. 7) with the fixed parameter, and obtains a feature vector (representation vector) of each of them. As an example, the inference unit 321 calculates the feature map 233 represented by the feature vector of each of the divided regions 251 using the contrastive learning model 230.

The inference unit 321 inputs the calculated feature map 233 to the object detection model 240, and estimates a label based on the object detection model 240. As an example, in a similar manner to the case illustrated in FIG. 6, the inference unit 321 estimates the bounding box 222 that is boundary position information of the object, a class of the object, the confidence level 228, and the like.

Note that a new object tracking model may be configured by inputting the estimation result of the object detection model 240 to the tracking model 214 illustrated in FIG. 4.

### [B-3] Exemplary Hardware Configuration of Information Processing Device 1 According to Embodiment

FIG. 11 is a block diagram illustrating an exemplary hardware (HW) configuration of a computer that implements functions of the information processing device 1 according to the embodiment.

As illustrated in FIG. 11, the information processing device 1 includes a central processing unit (CPU) 11, a memory unit 12, a display control unit 13, a storage device 14, an input interface (IF) 15, an external recording medium processing unit 16, and a communication IF 17.

The memory unit 12 is an exemplary storage unit, and illustratively is a read only memory (ROM), a random access memory (RAM), or the like. Programs of a basic input/output system (BIOS) and the like may be written in the ROM of the memory unit 12. A software program of the memory unit 12 may be appropriately read and executed by the CPU 11. Furthermore, the RAM of the memory unit 12 may be used as a temporary recording memory or a working memory.

The display control unit 13 is coupled to a display device 131, and controls the display device 131. The display device 131 is a liquid crystal display, an organic light-emitting diode (OLED) display, a cathode ray tube (CRT), an electronic paper display, or the like, and displays various kinds of information for an operator or the like. The display device 131 may be combined with an input device, and may be, for example, a touch panel.

The storage device 14 is a storage device having high input/output (I/O) performance, and for example, a dynamic random access memory (DRAM), a solid state drive (SSD), a storage class memory (SCM), or a hard disk drive (HDD) may be used. The storage device 14 may store a network configuration table 101.

The input IF 15 may be coupled to an input device such as a mouse 151 and a keyboard 152, and may control the input device such as the mouse 151 and the keyboard 152. The mouse 151 and the keyboard 152 are exemplary input devices, and the operator performs various input operations through those input devices.

The external recording medium processing unit 16 is configured in such a manner that a recording medium 160 may be attached thereto. The external recording medium processing unit 16 is configured in such a manner that information recorded in the recording medium 160 may be read in a state where the recording medium 160 is attached thereto. In the present example, the recording medium 160 is portable. For example, the recording medium 160 is a flexible disk, an optical disk, a magnetic disk, a magneto-optical disk, a semiconductor memory, or the like.

The communication IF 17 is an interface that enables communication with an external device.

The CPU 11 is an example of a processor (e.g., computer), and is a processing device that performs various controls and calculations. The CPU 11 implements various functions by executing an operating system (OS) or a program loaded into the memory unit 12. Note that the CPU 11 may be a multi-processor including a plurality of CPUs, or a multi-core processor having a plurality of CPU cores, or may have a configuration having a plurality of multi-core processors.

A device for controlling operation of the entire information processing device 1 is not limited to the CPU 11, and may be, for example, any one of an MPU, a DSP, an ASIC, a PLD, or an FPGA. Furthermore, the device for controlling operation of the entire information processing device 1 may be a combination of two or more types of the CPU, MPU, DSP, ASIC, PLD, and FPGA. Note that the MPU is an abbreviation for a micro processing unit, the DSP is an abbreviation for a digital signal processor, and the ASIC is an abbreviation for an application specific integrated circuit. Furthermore, the PLD is an abbreviation for a programmable logic device, and the FPGA is an abbreviation for a field-programmable gate array.

### [B-4] Exemplary Operation of Information Processing Device 1 According to Embodiment

### [B-4-1] Training Phase

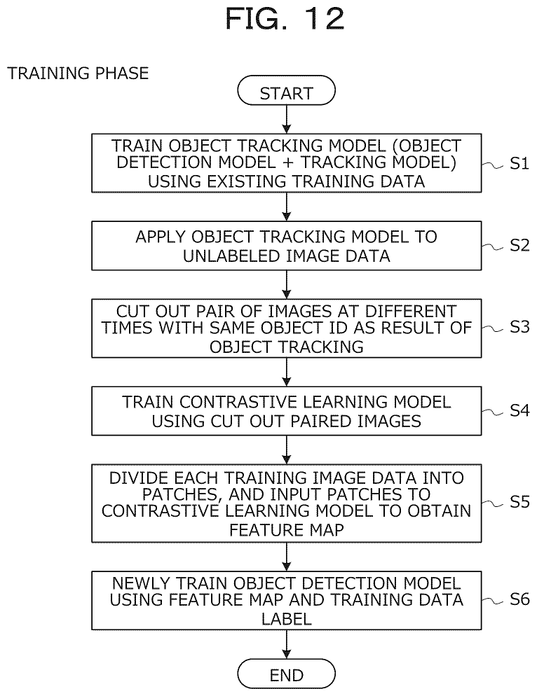

An example of operation in the training phase of the information processing device 1 according to the embodiment illustrated in FIG. 11 will be described based on a flowchart (operations S1 to S6) illustrated in FIG. 12.

The acquisition unit 312 obtains the existing training data 300. The first training execution unit 313 trains the object tracking model 210 using the existing training data 300 (operation S1). As illustrated in FIG. 4, the object tracking model 210 may include the object detection model 212 and the tracking model 214.

The object detection unit 314 applies the trained object tracking model 210 to the unlabeled moving image data 220 (operation S2). The object detection unit 314 detects each of the objects 223 in the unlabeled moving image data 220.

The ID allocation unit 315 determines the identity between the object 223-1 (e.g., first object) and the object 223-2 (e.g., second object) based on the inference result of the object tracking model 210. When the object 223-1 and the object 223-2 are the same object, the ID allocation unit 315 allocates the same identification information 225 (e.g., object ID) to the object 223-1 and the object 223-2. As a result of the object tracking, the image acquisition unit 316 cuts out a pair of images at different times having the same identification information 225 (e.g., object ID) (operation S3).

As an example, the paired images are the first data 226 and the second data 227. The first data 226 is image data in the first image area including the object 223-1, and the second data 227 is image data in the second image area including the object 223-2.

The second training execution unit 317 inputs the first data 226 and the second data 227, which are the paired images, to the contrastive learning model 230 to train the contrastive learning model 230 (operation S4).

The patch generation unit 319 obtains the training image data 250 as training data. The patch generation unit 319 divides the training image data 250 into a plurality of patches, and inputs them to the contrastive learning model 230 with a fixed parameter to obtain the feature map 233 (operation S5).

The third training execution unit 318 newly trains the object detection model 240 using the feature map 233 and the label 253 of the training image data 250 (operation S6). Then, the process in the training phase is terminated.

### [B-4-2] Inference Phase

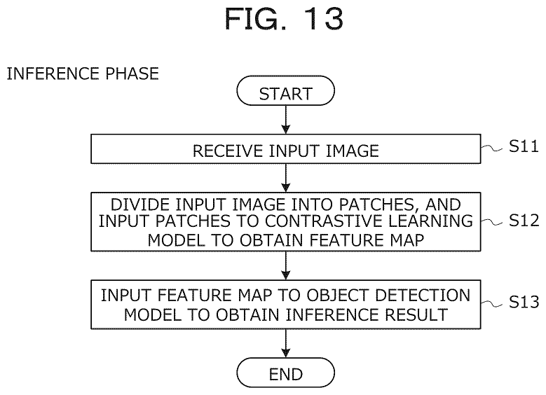

An example of operation in the inference phase of the information processing device 1 according to the embodiment illustrated in FIG. 11 will be described based on a flowchart (operations S11 to S13) illustrated in FIG. 13.

The control unit 320 receives at least one input image 260 (operation S11).

The patch generation unit 319 obtains the input image 260. The patch generation unit 319 divides the input image 260 into a plurality of patches. The inference unit 321 inputs each of the divided patches to the trained contrastive learning model 230 (see FIG. 7) with the fixed parameter, and obtains a feature vector (e.g., representation vector) of each of them. As an example, the inference unit 321 obtains the feature map 233 represented by the feature vector of each of the divided regions using the contrastive learning model 230 (operation S12). The feature map 233 is similar to the feature map 233 except for the difference regarding whether the target image is the training image data 250 or the input image 260.

The inference unit 321 inputs the calculated feature map 233 to the object detection model 240 to obtain the inference result 270 regarding the object detection (operation S13). Then, the process in the inference phase is terminated.

### [C] First Variation

### [C-1] Description of Training Process According to First Variation

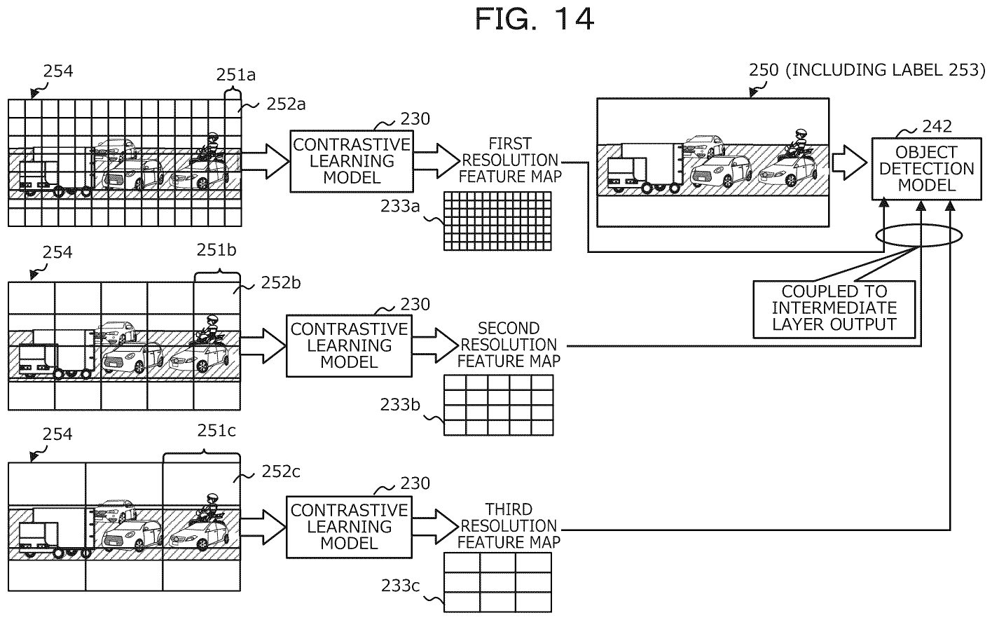

FIG. 14 is a diagram illustrating an exemplary training process of an object detection model 242 by an information processing device 1 according to a first variation. The object detection model 242 is an exemplary second machine learning model that detects an object from an image based on a trained contrastive learning model 230.

The process of the first variation is in common with the case of the embodiment regarding the processes illustrated in FIGS. 3 to 7. Therefore, repetitive description will be omitted. The process of the first variation includes the process illustrated in FIG. 14 instead of the process of the embodiment illustrated in FIG. 8.

As illustrated in FIG. 14, in the first variation, a patch generation unit 319 of a control unit 320 obtains respective divided images 252 according to a first division resolution (e.g., high resolution), a second division resolution (e.g., medium resolution), and a third division resolution (e.g., low resolution).

As an example, the patch generation unit 319 divides the input training image data 250 into a plurality of first divided regions 251a according to the first division resolution to obtain a plurality of first divided images 252a. Furthermore, the patch generation unit 319 divides the input training image data 250 into a plurality of second divided regions 251b according to the second division resolution different from the first division resolution to obtain a plurality of second divided images 252b. Moreover, the patch generation unit 319 divides the input training image data 250 into a plurality of third divided regions 251c according to the third division resolution different from the first and second division resolutions to obtain a plurality of third divided images 252c.

A third training execution unit 318 inputs each of the first divided images 252a to the trained contrastive learning model 230 (see FIG. 7) with a fixed parameter, and obtains a feature vector (e.g., representation vector) of each of them. As an example, the third training execution unit 318 calculates a first resolution feature map 233a represented by the feature vector of each of the first divided regions 251a.

Likewise, the third training execution unit 318 inputs each of the second divided images 252b to the contrastive learning model 230 to obtain a feature vector (e.g., representation vector) of each of them. As an example, the third training execution unit 318 calculates a second resolution feature map 233b represented by the feature vector of each of the second divided regions 251b.

The third training execution unit 318 inputs each of the third divided images 252c to the contrastive learning model 230 to obtain a feature vector (e.g., representation vector) of each of them. As an example, the third training execution unit 318 calculates a third resolution feature map 233c represented by the feature vector of each of the third divided regions 251c.

The third training execution unit 318 trains the object detection model 242 based on the first resolution feature map 233a, the second resolution feature map 233b, the third resolution feature map 233c, and the training image data 250. As an example, the training image data 250 may be supervised training data including image data and a label 253.

As an example, the training image data 250 (including the label 253) may be input to an input layer of the object detection model 242. Each of the outputs of the contrastive learning model 230 (first resolution feature map 233a, second resolution feature map 233b, third resolution feature map 233c, etc.) may be coupled to an intermediate layer output of the object detection model 242.

The object detection model 242 may be a deep neural network (DNN)-based object detection model. In this case, the intermediate layer outputs of the object detection model 242 may correspond to mutually different resolutions. As an example, in a case of a convolutional neural network (CNN)-based object detection model, object detection is carried out while gradually reducing the internal image resolution as getting closer to an output layer.

In a case where resolutions of the individual intermediate layer outputs of the object detection model 242 are known, the individual division resolutions such as the first division resolution, the second division resolution, the third division resolution, and the like may correspond to the resolutions of the individual intermediate layer outputs. In this case, the resolution feature map of the division resolution corresponding to the intermediate layer output resolution is coupled to the intermediate layer.

In a case where a plurality of types of objects 223 having different sizes is present, the object detection model 242 is trained by a plurality of types of feature maps (233a, 233b, and 233c) obtained by being divided into patches having sizes corresponding to the plurality of types of division resolutions. Therefore, it becomes possible to improve the accuracy in detecting the objects 223 having different sizes.

While FIG. 14 illustrates the case of the three-stage division resolution of the first to third division resolutions, the present embodiment is not limited to this case, and a division resolution of two or more stages may be sufficient. The stage of the division resolution may be set according to the number of convolution layers and pooling layers of the object detection model 242.

Except for the points above, the training process of the object detection model 242 according to the first variation is similar to the case of the embodiment. Therefore, description regarding a software configuration and a hardware configuration of the information processing device 1 according to the first variation will be omitted.

### [C-2] Exemplary Operation of Information Processing Device 1 According to First Variation

### [C-2-1] Training Phase

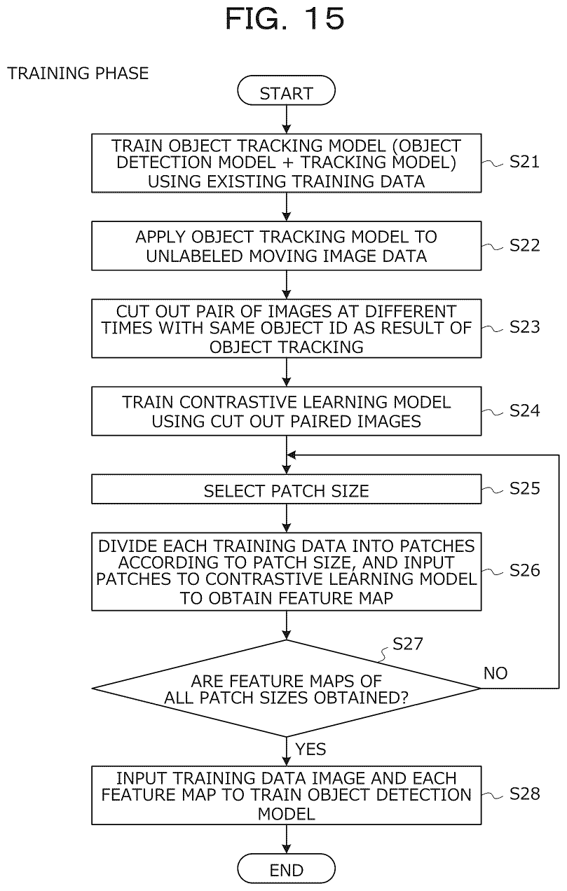

An example of operation in a training phase of the information processing device 1 according to the first variation will be described based on a flowchart (operations S21 to S28) illustrated in FIG. 15.

Processes of operations S21 to S24 are similar to the processes of operations S1 to S4 in FIG. 12, respectively. Therefore, description thereof will be omitted.

The patch generation unit 319 selects a patch size (operation S25). The patch size may be a side length of the divided region 251. The patch size may be inversely proportional to the division resolution. The division resolution becomes lower as the patch size increases. A type of the patch size may be set in advance.

The patch generation unit 319 divides the training image data 250 into patches according to the selected patch size, inputs them to the contrastive learning model 230 with a fixed parameter, and obtains a feature map (e.g., first resolution feature map 233a) (operation S26).

The patch generation unit 319 determines whether or not feature maps of all patch sizes have been obtained (operation S27). If there is a feature map of a patch size that has not been obtained yet (see NO route in operation S27), the patch generation unit 319 selects the next patch size (operation S25). If feature maps of all the patch sizes have been obtained (see YES route in operation S27), the process proceeds to operation S28.

The third training execution unit 318 inputs, to the object detection model 242, the individual feature maps (233a, 233b, and 233c) and the label 253 and the image of the training image data 250 as training data, thereby training the object detection model 242 (operation S28). Then, the process in the training phase is terminated.

### [C-2-2] Inference Phase

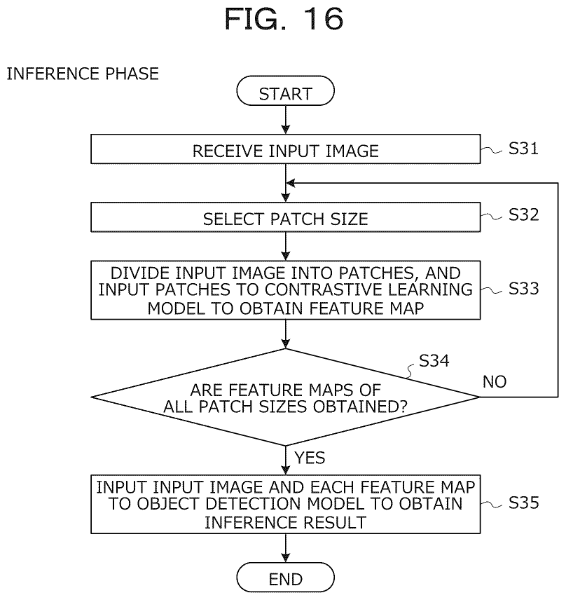

An example of operation in an inference phase of the information processing device 1 according to the first variation will be described based on a flowchart (operations S31 to S35) illustrated in FIG. 16.

The control unit 320 receives at least one input image 260 (operation S31).

The patch generation unit 319 selects a patch size (operation S32).

The patch generation unit 319 divides the input image 260 into patches according to the selected patch size, inputs them to the contrastive learning model 230 with the fixed parameter, and obtains a feature map (e.g., first resolution feature map 233a) (operation S33).

The patch generation unit 319 determines whether or not feature maps of all patch sizes have been obtained (operation S34). If there is a feature map of a patch size that has not been obtained yet (see NO route in operation S34), the patch generation unit 319 selects the next patch size (operation S32). If feature maps of all the patch sizes have been obtained (see YES route in operation S34), the process proceeds to operation S35.

In operation S35, the inference unit 321 inputs the input image 260 and the individual feature maps (233a, 233b, and 233c) to the object detection model 242 to obtain an inference result 270 regarding the object detection.

### [D] Second Variation

### [D-1] Description of Training Process According to Second Variation

In the embodiment and the first variation, the case where the contrastive learning model 230 (encoder) is provided separately from the object detection models 240 and 242 has been described. However, the present embodiment is not limited to this case. In a machine learning method according to a second variation, a part of functions of an object detection model is used as a contrastive learning model (e.g., encoder).

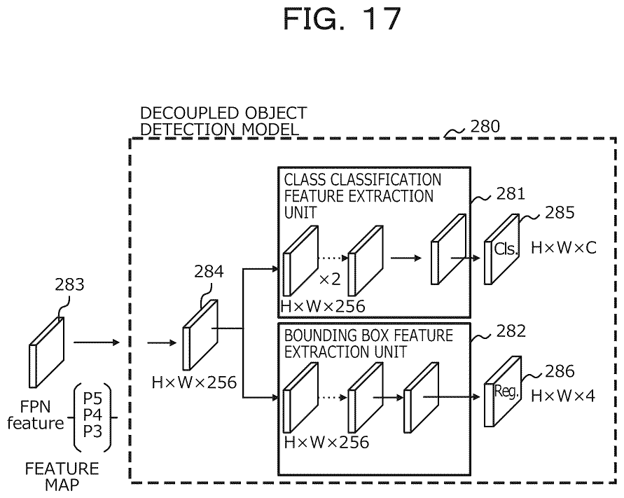

FIG. 17 is a diagram illustrating a decoupled object detection model 280 according to the second variation. The decoupled object detection model 280 is an example of the object detection model, and is an example of a second machine learning model.

In the decoupled object detection model 280 (e.g., decoupled object detection head), a class classification feature extraction unit 281 and a bounding box feature extraction unit 282 are separated. The class classification feature extraction unit 281 extracts a feature for class classification of the object detection function. The bounding box feature extraction unit 282 extracts a feature for bounding box generation. The class classification feature extraction unit 281 is an exemplary class classification model for outputting a feature related to object class classification. The bounding box feature extraction unit 282 is an exemplary position information model that outputs a feature related to object boundary position information in a moving image.

When a feature map 283 is input to the decoupled object detection model 280, it is divided into the class classification feature extraction unit 281 and the bounding box feature extraction unit 282 by an input unit 284.

An output from the class classification feature extraction unit 281 is subject class classification by a class classification unit 285. An output from the bounding box feature extraction unit 282 is input to a bounding box regression prediction unit 286 (regression). The bounding box regression prediction unit 286 calculates a position of the bounding box.

As an example, the decoupled object detection model 280 may be a YOLOX-based object detection model.

In the second variation, the class classification feature extraction unit 281 of the decoupled object detection model 280 is used as a contrastive learning model. The class classification feature extraction unit 281 is an example of the encoder.

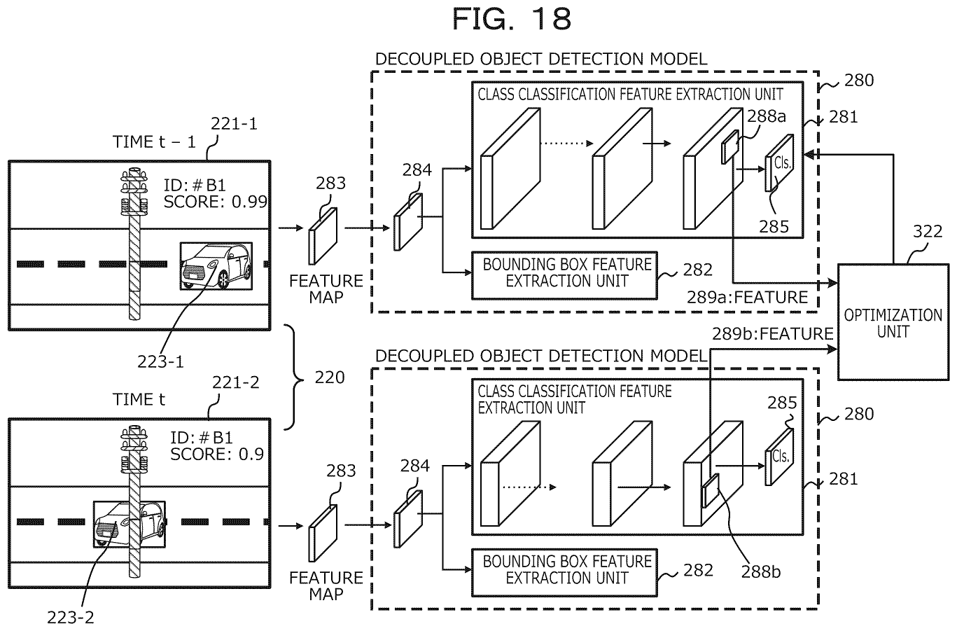

FIG. 18 is a diagram illustrating an exemplary training process of the decoupled object detection model 280 by an information processing device 1 according to the second variation.

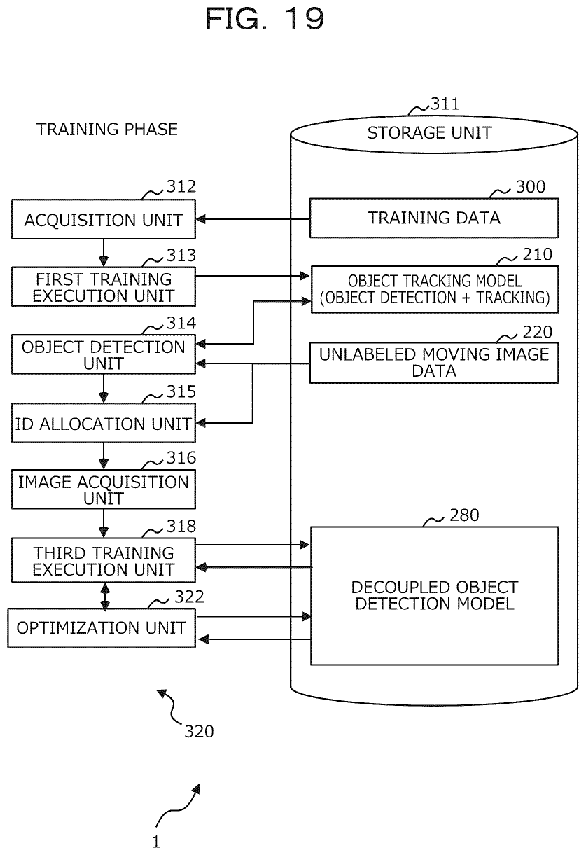

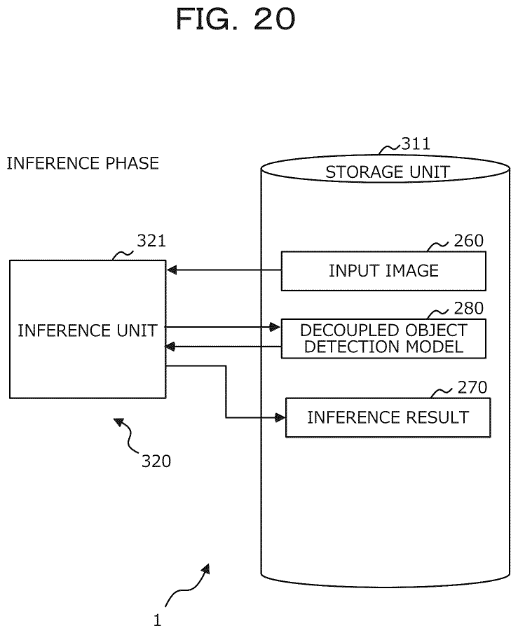

FIG. 19 is a block diagram illustrating an exemplary functional configuration in a training phase by the information processing device 1 according to the second variation. FIG. 20 is a block diagram illustrating an exemplary functional configuration in an inference phase by the information processing device 1 according to the second variation.

As illustrated in FIGS. 19 and 20, as compared with the information processing device 1 according to the embodiment, a second training execution unit 317 may be omitted in the information processing device 1 according to the second variation. A third training execution unit 318 implements a function of the second training execution unit 317. A patch generation unit 319 may be omitted in the information processing device 1 according to the second variation.

As illustrated in FIGS. 18 and 19, an optimization unit 322 may be provided. As will be described later, the optimization unit 322 carries out machine learning of the class classification feature extraction unit 281 to increase a degree of matching between a value of a first element 288a (e.g., first class classification feature) and a value of a second element 288b (e.g., second class classification feature).

The information processing device 1 according to the second variation performs a process similar to the process illustrated in FIGS. 3 to 6 according to the embodiment. The information processing device 1 obtains a first frame image (e.g., frame image 221-1) and a second frame image (e.g., frame image 221-2) including objects 223-1 (e.g., first object) and 223-2 (e.g., second object), respectively, which are the mutually same object.

When the object 223-1 (e.g., first object) and the object 223-2 (e.g., second object) are determined to be identical to each other, an image acquisition unit 316 obtains first data 226 and second data 227.

In the embodiment and the first variation, the case where the first data 226 is image data cut out from the frame image 221-1 according to the shape and position of the bounding box 222-1 has been mainly described. Likewise, the case where the second data 227 is image data cut out from the frame image 221-2 has been described.

In the second variation, the first data 226 may be the entire frame image 221-1. The second data 227 may be the entire frame image 221-2.

In the second variation, the third training execution unit 318 (also serving as the second training execution unit 317) inputs each of the first data 226 and the second data 227 to the class classification feature extraction unit 281 that also functions as a contrastive learning model.

In a case where the objects (223-1 and 223-2), which are the same object, have been detected at different times (t−1 and t) as a result of object tracking, the third training execution unit 318 obtains the first element 288a (at t−1) and the second element 288b (at t) in the feature map corresponding to the positions of the objects (223-1 and 223-2) at the respective times. The third training execution unit 318 obtains the value of the first element 288a and the value of the second element 288b.

The value of the first element 288a is an example of a first class classification feature 289a obtained by inputting the first data 226 to the class classification model. The value of the second element 288b is an example of a second class classification feature 289b obtained by inputting the second data 227 to the class classification model.

There may be a plurality of pairs of the objects 223. The number of pairs may be determined in advance.

The optimization unit 322 carries out machine learning of the class classification feature extraction unit 281 to increase a degree of matching between the first class classification feature 289a (zᵢ) and the second class classification feature 289b (zⱼ). The optimization unit 322 may calculate a loss function L_{φ}=−sim(zᵢ, zⱼ), and may update the parameter φ such that a value of the loss function L_{φ} is minimized.

Since the extracted first class classification feature 289a (zᵢ) and the second class classification feature 289b (zⱼ) are features for the same object, a concept similar to that of contrastive learning may be applied.

The machine learning of the class classification by the class classification feature extraction unit 281 and the like, the machine learning of the boundary position information by the bounding box feature extraction unit 282 and the like, and the contrastive learning may be carried out in parallel. In this case, labeled moving image data may be input instead of unlabeled moving image data 220.

The training may be carried out even in the case of using a part of the functions of the object detection model (decoupled object detection model 280) as a contrastive learning model (encoder) as in the second variation, and the training suitable for the object detection may be carried out as compared with the case of training the contrastive learning model separately.

### [D-2] Exemplary Operation of Information Processing Device 1 According to Second Variation

### [D-2-1] Training Phase

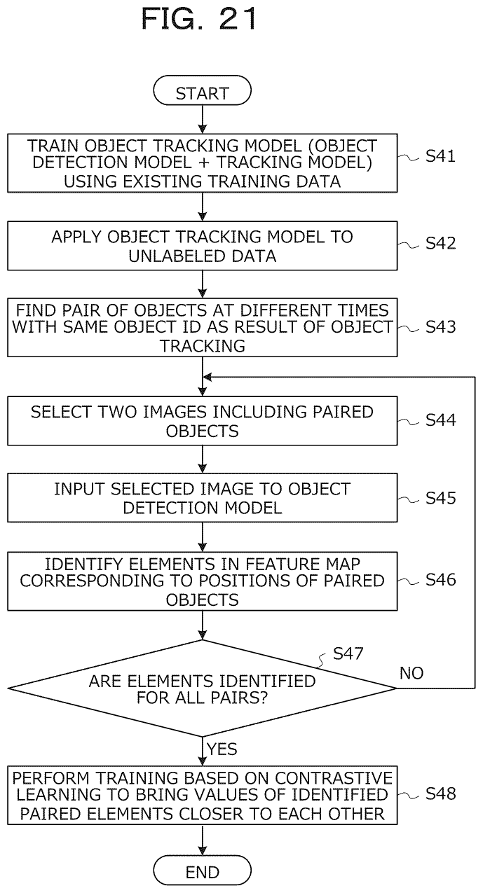

An example of operation in the training phase of the information processing device 1 according to the second variation will be described based on a flowchart (operations S41 to S48) illustrated in FIG. 21.

Processes of operations S41 and S42 are similar to the processes of operations S1 and S2 in FIG. 12, respectively. Therefore, description thereof will be omitted.

The ID allocation unit 315 determines the identity between the object 223-1 (e.g., first object) and the object 223-2 (e.g., second object) based on the inference result of the object tracking model 210. When the object 223-1 and the object 223-2 are the same object, the ID allocation unit 315 allocates the same identification information 225 (e.g., object ID) to the object 223-1 and the object 223-2. As a result of the object tracking, the image acquisition unit 316 finds a pair of the objects 223-1 and 223-2 at different times having the same identification information 225 (e.g., object ID) (operation S43).

The image acquisition unit 316 selects images including the paired objects 223-1 and 223-2 (operation S44). The paired images may be the entire frame image 221-1 and the entire frame image 221-2.

The third training execution unit 318 inputs each of the selected paired images (e.g., first data 226 and second data 227) to the object detection model (operation S45). As an example, the entire frame image 221-1 and the entire frame image 221-2 are input to the decoupled object detection model 280.

The third training execution unit 318 identifies the first element 288a and the second element 288b in the feature map corresponding to the positions of the objects 223-1 and 223-2 at the respective times (operation S46).

The third training execution unit 318 determines whether or not the first element 288a and the second element 288b have been identified for all the paired objects 223 determined to be identical (operation S47). If the first element 288a and the second element 288b have not been identified for all the paired objects 223 determined to be identical (see NO route in operation S47), the third training execution unit 318 selects an image including other paired objects (operation S44). If the first element 288a and the second element 288b have been identified for all the paired objects 223 determined to be identical (see YES route in operation S47), the process proceeds to operation S48.

The optimization unit 322 carries out machine learning of the class classification feature extraction unit 281 by contrastive learning to increase the degree of matching between the value of the first element 288a and the value of the second element 288b identified for all the pairs (operation S48). The optimization unit 322 carries out machine learning of the class classification feature extraction unit 281 to increase a degree of matching between the first class classification feature 289a (zᵢ) and the second class classification feature 289b (zⱼ). The optimization unit 322 may calculate the loss function L_{φ}=−sim(zᵢ, zⱼ) for each pair, and may update the parameter φ such that the sum of the loss functions L_{φ} for all the pairs is minimized. Then, the process in the training phase is terminated.

### [D-2-2] Inference Phase

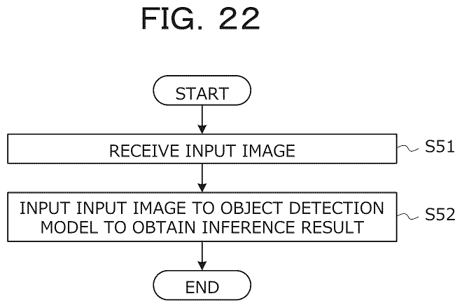

An example of operation in the inference phase of the information processing device 1 according to the second variation will be described based on a flowchart (operations S51 and S52) illustrated in FIG. 22.

A control unit 320 receives at least one input image 260 (operation S51).

The input image 260 is input to the decoupled object detection model 280, which is a trained object detection model with a fixed parameter, to obtain an inference result 270 (operation S52). Then, the process in the inference phase is terminated.

### [E] Effects

According to the exemplary embodiment described above, for example, the following effects may be exerted.

The control unit 320 inputs, to the object tracking model 210 trained by using the training data 300, the unlabeled moving image data 220 including at least the first frame image (frame image 221-1, etc.) and the second frame image (frame image 221-2, etc.). The control unit 320 detects the object 223-1 (e.g., first object) and the object 223-2 (e.g., second object) from the first frame image (frame image 221-1, etc.) and the second frame image (frame image 221-2, etc.), respectively, based on the inference result of the object tracking model 210. The control unit 320 determines identity between the object 223-1 and the object 223-2 having been detected. The control unit 320 inputs, to the contrastive learning model 230, the first data 226 in the first image area including the object 223-1 and the second data 227 in the second image area including the object 223-2 determined to be identical, and trains the contrastive learning model 230.

As a result, it becomes possible to reduce an influence of a perturbation caused by the occlusion 224 or the like to improve performance of object detection. Since the volume of the training data may be increased by the contrastive learning model 230, it becomes possible to suppress deterioration in object detection performance caused by over-training or the like.

It is possible to obtain paired images for contrastive learning in consideration of differences and the like such as an angle of the object 223, presence or absence of the occlusion 224, presence or absence of a motion blur, a difference in illumination, and the like without passing through special data extension processing. A wide variety of training data may be obtained as compared with a method of increasing labels in a pseudo manner based on label propagation. Therefore, it becomes possible to achieve object detection robust (e.g., resistant) to the differences such as the angle of the object 223, the presence or absence of the occlusion 224, the presence or absence of the motion blur, the difference in illumination, and the like.

In the process of training the contrastive learning model 230, the control unit 320 carries out the machine learning to increase the degree of matching between the first feature obtained by inputting the first data 226 to the contrastive learning model 230 and the second feature obtained by inputting the second data 227 to the contrastive learning model 230.

As a result, the contrastive learning model 230 robust to the perturbation caused by the occlusion 224 or the like may be obtained.

The control unit 320 trains the object detection model 240 that detects an object from an image based on the trained contrastive learning model 230.

It becomes possible to train the object detection model 240 utilizing the contrastive learning model 230 robust to the perturbation caused by the occlusion 224 or the like, which enables more robust object detection. Since volume of a variety of training data may be increased by the contrastive learning model 230, over-training is suppressed.

In the process of training the object detection model 240, the control unit 320 divides the input training image data 250 into a plurality of divided regions 251 to obtain a plurality of divided images 252. The control unit 320 inputs the divided images 252 of the individual divided regions 251 to the contrastive learning model 230, calculates a feature in each of the divided regions 251, and trains the object detection model 240 based on the calculated result and the label 253 corresponding to the input training image data 250.

As a result, it becomes possible to reflect the training result of the contrastive learning model 230 in the object detection model 240 without complicating the configuration.

In the process of training the object detection model 242, the control unit 320 divides the input training image data 250 into a plurality of first divided regions 251a according to the first division resolution to obtain a plurality of first divided images 252a. The control unit 320 divides the input training image data 250 into a plurality of second divided regions 251b according to the second division resolution different from the first division resolution to obtain a plurality of second divided images 252b. The control unit 320 inputs the first divided image 252a in each of the first divided regions 251a to the contrastive learning model 230 to obtain the first resolution feature map 233a indicating the feature of each of the first divided regions 251a. The control unit 320 inputs the second divided image 252b in each of the second divided regions 251b to the contrastive learning model 230 to obtain the second resolution feature map 233b indicating the feature of each of the second divided regions 251b. The control unit 320 trains the object detection model 242 based on the first resolution feature map 233a, the second resolution feature map 233b, and the training image data 250.

As a result, it becomes possible to effectively improve the object detection performance even when the object to be detected appears in various scales in the image.

As the object detection model, the decoupled object detection model 280 is used including the position information model that outputs a feature related to boundary position information of an object in a moving image and the class classification feature extraction unit 281 (e.g., class classification model) for outputting a feature related to class classification of the object. In the decoupled object detection model 280, the class classification feature extraction unit 281 is used as a contrastive learning model (e.g., encoder). The control unit 320 carries out the machine learning to increase the degree of matching between the first class classification feature 289a obtained by inputting the first data 226 to the class classification feature extraction unit 281 and the second class classification feature 289b obtained by inputting the second data 227 to the class classification feature extraction unit 281.

As a result, it becomes possible to utilize a part of the object detection model (e.g., decoupled object detection model 280) as the contrastive learning model, and to achieve processing with high compatibility between object detection and contrastive learning.

### [F] Others

The disclosed technique is not limited to the embodiment described above, and various modifications may be made without departing from the gist of the present embodiment. Each configuration and each process of the present embodiment may be selected or omitted as needed, or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process, the process comprising:
inputting moving image data that includes at least a first frame image and a second frame image to a first machine learning model trained by using training data; and
training an encoder by
detecting a first object and a second object from the first frame image and the second frame image, respectively, based on an inference result by the first machine learning model,
determining identity between the first object and the second object that have been detected, and
inputting, to the encoder, first data in a first image area that includes the first object and second data in a second image area that includes the second object, the first object and the second object having been determined to have the identity.

2. The non-transitory computer-readable recording medium according to claim 1, wherein the process, in the training the encoder, performs machine learning to increase a degree of matching between a first feature obtained by inputting the first data to the encoder and a second feature obtained by inputting the second data to the encoder.

3. The non-transitory computer-readable recording medium according to claim 1, the process further comprising:
training a second machine learning model that detects an object from an image, based on the trained encoder.

4. The non-transitory computer-readable recording medium according to claim 3,
wherein the process, in the training the second machine learning model,
obtains a plurality of divided images by dividing input image data into a plurality of divided regions,
obtains a feature in each of the divided regions by inputting the divided images in the respective divided regions to the encoder, and
trains the second machine learning model, based on the obtained feature and a label that corresponds to the input image data.

5. The non-transitory computer-readable recording medium according to claim 3,
wherein the process, in the training the second machine learning model,
obtains a plurality of first divided images by dividing input image data into a plurality of first divided regions according to a first division resolution,
obtains a plurality of second divided images by dividing the input image data into a plurality of second divided regions according to a second division resolution different from the first division resolution,
obtains a first resolution feature map that indicates a feature in each of the first divided regions by inputting the first divided images in the respective first divided regions to the encoder,
obtains a second resolution feature map that indicates a feature in each of the second divided regions by inputting the second divided images in the respective second divided regions to the encoder, and
trains the second machine learning model, based on the first resolution feature map, the second resolution feature map, and the image data.

6. The non-transitory computer-readable recording medium according to claim 1,
wherein the process
uses a class classification model as the encoder in a second machine learning model that includes a position information model that outputs a feature related to boundary position information of an object in a moving image and a class classification model that outputs a feature related to class classification of the object, and
performs machine learning to increase a degree of matching between a first class classification feature obtained by inputting the first data to the class classification model and a second class classification feature obtained by inputting the second data to the class classification model.

7. A machine learning method for causing a computer to execute a process, the process comprising:
inputting moving image data that includes at least a first frame image and a second frame image to a first machine learning model trained by using training data; and
training an encoder by
detecting a first object and a second object from the first frame image and the second frame image, respectively, based on an inference result by the first machine learning model,
determining identity between the first object and the second object that have been detected, and
inputting, to the encoder, first data in a first image area that includes the first object and second data in a second image area that includes the second object, the first object and the second object having been determined to have the identity.

8. The machine learning method according to claim 7, wherein the process, in the training the encoder, performs machine learning to increase a degree of matching between a first feature obtained by inputting the first data to the encoder and a second feature obtained by inputting the second data to the encoder.

9. The machine learning method according to claim 7, the process further comprising:
training a second machine learning model that detects an object from an image, based on the trained encoder.

10. The machine learning method according to claim 9,
wherein the process, in the training the second machine learning model,
obtains a plurality of divided images by dividing input image data into a plurality of divided regions,
obtains a feature in each of the divided regions by inputting the divided images in the respective divided regions to the encoder, and
trains the second machine learning model, based on the obtained feature and a label that corresponds to the input image data.

11. The machine learning method according to claim 9,
wherein the process, in the training the second machine learning model,
obtains a plurality of first divided images by dividing input image data into a plurality of first divided regions according to a first division resolution,
obtains a plurality of second divided images by dividing the input image data into a plurality of second divided regions according to a second division resolution different from the first division resolution,
obtains a first resolution feature map that indicates a feature in each of the first divided regions by inputting the first divided images in the respective first divided regions to the encoder,
obtains a second resolution feature map that indicates a feature in each of the second divided regions by inputting the second divided images in the respective second divided regions to the encoder, and
trains the second machine learning model, based on the first resolution feature map, the second resolution feature map, and the image data.

12. The machine learning method according to claim 7,
wherein the process
uses a class classification model as the encoder in a second machine learning model that includes a position information model that outputs a feature related to boundary position information of an object in a moving image and a class classification model that outputs a feature related to class classification of the object, and
performs machine learning to increase a degree of matching between a first class classification feature obtained by inputting the first data to the class classification model and a second class classification feature obtained by inputting the second data to the class classification model.

13. An information processing device comprising:
a memory; and
a processor coupled to the memory and configured to:
input moving image data that includes at least a first frame image and a second frame image to a first machine learning model trained by using training data; and
train an encoder by
detecting a first object and a second object from the first frame image and the second frame image, respectively, based on an inference result by the first machine learning model,
determining identity between the first object and the second object that have been detected, and
inputting, to the encoder, first data in a first image area that includes the first object and second data in a second image area that includes the second object, the first object and the second object having been determined to have the identity.

14. The information processing device according to claim 13, wherein the processor, in the training the encoder, performs machine learning to increase a degree of matching between a first feature obtained by inputting the first data to the encoder and a second feature obtained by inputting the second data to the encoder.

15. The information processing device according to claim 13, the processor is further configured to:
train a second machine learning model that detects an object from an image, based on the trained encoder.

16. The information processing device according to claim 15,
wherein the processor, in the training the second machine learning model,
obtains a plurality of divided images by dividing input image data into a plurality of divided regions,
obtains a feature in each of the divided regions by inputting the divided images in the respective divided regions to the encoder, and
trains the second machine learning model, based on the obtained feature and a label that corresponds to the input image data.

17. The information processing device according to claim 15,
wherein the processor, in the training the second machine learning model,
obtains a plurality of first divided images by dividing input image data into a plurality of first divided regions according to a first division resolution,
obtains a plurality of second divided images by dividing the input image data into a plurality of second divided regions according to a second division resolution different from the first division resolution,
obtains a first resolution feature map that indicates a feature in each of the first divided regions by inputting the first divided images in the respective first divided regions to the encoder,
obtains a second resolution feature map that indicates a feature in each of the second divided regions by inputting the second divided images in the respective second divided regions to the encoder, and
trains the second machine learning model, based on the first resolution feature map, the second resolution feature map, and the image data.

18. The information processing device according to claim 13,
wherein the processor
uses a class classification model as the encoder in a second machine learning model that includes a position information model that outputs a feature related to boundary position information of an object in a moving image and a class classification model that outputs a feature related to class classification of the object, and
performs machine learning to increase a degree of matching between a first class classification feature obtained by inputting the first data to the class classification model and a second class classification feature obtained by inputting the second data to the class classification model.
